(19) United States
(12) Patent Application Publication
(10) Pub. No.: US 2017/0066623 A1
(43) Pub. Date: Mar. 9, 2017

(54) ROPELESS ELEVATOR CONTROL SYSTEM

(71) Applicant: OTIS ELEVATOR COMPANY, Farmington, CT (US)

(72) Inventors: Andrzej Ernest Kuczek, Bristol, CT (US); Enrico Manes, Feeding HIlls, MA (US); Joseph C. Rampone, Colchester, CT (US)

(21) Appl. No.: 15/254,615

(22) Filed: Sep. 1, 2016

Related U.S. Application Data
(60) Provisional application No. 62/214,286, filed on Sep. 4, 2015.

(51) Int. Cl. B66B 1/28; B66B 5/00; B66B 9/00

(52) U.S. Cl. CPC B66B 1/28; B66B 9/003; B66B 5/0012

(57) ABSTRACT

A ropeless elevator system includes an elevator car constructed and arranged to move along a hoistway and into a transfer station that is in communication with the hoistway. An electronic controller of the ropeless elevator system is configured to control the speed of the elevator car when at least when the elevator car is in the transfer station. A first detector of the ropeless elevator system is supported by the elevator car and is configured to send a first signal to the electronic controller at least in-part indicative of a presence in the elevator car. If a presence is detected the electronic controller outputs a speed control signal indicative of the presence.

### CROSS REFERENCE TO RELATED APPLICATION

This application claims priority to U.S. Provisional Patent Application No. 62/214,286, filed Sep. 4, 2015, the entire contents of which is incorporated herein by reference.

The present disclosure relates to ropeless elevator systems, and more particularly to an elevator control system.

Self-propelled elevator systems, also referred to as ropeless elevator systems, are useful in certain applications (e.g., high rise buildings) where the mass of the ropes for a roped system is prohibitive and there is a desire for multiple elevator cars to travel in a single lane. There exist self-propelled elevator systems in which a first lane is designated for upward traveling elevator cars and a second lane is designated for downward traveling elevator cars. At least one transfer station is provided in the hoistway to move cars horizontally between the first lane and second lane. Improvements in car transfers between lanes is desirable.

### SUMMARY

A ropeless elevator system according to one, non-limiting, embodiment of the present disclosure includes an elevator car constructed and arranged to move along a hoistway and into a transfer station in communication with the hoistway; an electronic controller configured to control speed of the elevator car when at least in the transfer station; and a first detector supported by the elevator car and configured to send a first signal to the electronic controller at least in-part indicative of a presence in the elevator car, and wherein the electronic controller outputs a speed control signal indicative of the presence.

Additionally to the foregoing embodiment, the first detector is a load detector.

In the alternative or additionally thereto, in the foregoing embodiment, the first detector is a video detector.

In the alternative or additionally thereto, in the foregoing embodiment, the first detector is an infrared detector configured to measure at least temperature.

In the alternative or additionally thereto, in the foregoing embodiment, the ropeless elevator system includes an infrared detector supported by the elevator car and configured to send a temperature signal to the electronic controller indicative of the presence being human, and wherein the first detector is a load detector indicative of the existence of the presence in the elevator car.

In the alternative or additionally thereto, in the foregoing embodiment, the ropeless elevator system includes a visual detector supported by the elevator car and configured to send an imaging signal to the electronic controller for detecting the presence, and wherein the first detector is a load detector.

In the alternative or additionally thereto, in the foregoing embodiment, the ropeless elevator system includes a system user interface configured to receive an information signal outputted by the electronic controller and based on the presence, and configured to send a command signal to the electronic controller initiated by a human user.

In the alternative or additionally thereto, in the foregoing embodiment, a drive device constructed and arranged to move the elevator car in the transfer station, and wherein the speed control signal is received by the drive device and is indicative of a safe mode transfer speed that is slower than a normal mode transfer speed applied when the elevator car is empty.

In the alternative or additionally thereto, in the foregoing embodiment, the electronic controller is configured to output an indeterminate signal to the drive device when the presence is indeterminate and the drive device is constructed and arranged to stop the elevator car upon receipt of the indeterminate signal.

In the alternative or additionally thereto, in the foregoing embodiment, the ropeless elevator system includes a system user interface configured to receive an information signal outputted by the electronic controller and based on the indeterminate signal, and configured to send a command signal to the electronic controller initiated by a human user commensurate of selectively running the elevator car at the safe mode transfer speed or the normal mode transfer speed.

In the alternative or additionally thereto, in the foregoing embodiment, the ropeless elevator system includes an occupant interface supported by the elevator car and configured to receive a notice signal outputted by the electronic controller and providing notice information to the elevator car occupants.

In the alternative or additionally thereto, in the foregoing embodiment, the notice information is instruction to leave the elevator car.

A method of transferring an elevator car from a hoistway and into a transfer station according to another, non-limiting, embodiment includes monitoring an elevator car for a presence by an electronic controller; automatically moving the elevator car from the hoistway and into the transfer station at a slow speed if the presence is detected; and automatically moving the elevator car from the hoistway and into the transfer station at a normal speed greater than the slow speed if the presence is not detected.

Additionally to the foregoing embodiment, the monitoring is conducted by detector configured to send a signal to the electronic controller indicative of a presence.

In the alternative or additionally thereto, in the foregoing embodiment, the detector is constructed and arranged to detect the presence as a human presence.

In the alternative or additionally thereto, in the foregoing embodiment, a speed control signal is outputted by the controller for automatically moving the elevator car from the hoistway and into the transfer station at the slow speed.

In the alternative or additionally thereto, in the foregoing embodiment, the method includes automatically stopping the elevator car by the controller and prior to moving the elevator car into the transfer station if the existence of the presence in the elevator car is indeterminate.

In the alternative or additionally thereto, in the foregoing embodiment, the method includes displaying a visual image of the elevator car upon a system user interface at least when the existence of the presence is indeterminate.

In the alternative or additionally thereto, in the foregoing embodiment, the method includes re-initiating movement of the elevator car by a supervising human through the system user interface and based on the visual image.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 depicts a multicar elevator system in an exemplary embodiment;

FIG. 2 is a top down view of a car and portions of a linear propulsion system in an exemplary embodiment;

FIG. 3 is a schematic of the linear propulsion system; and

FIG. 4 is a schematic of a control system of the linear propulsion system.

### DETAILED DESCRIPTION

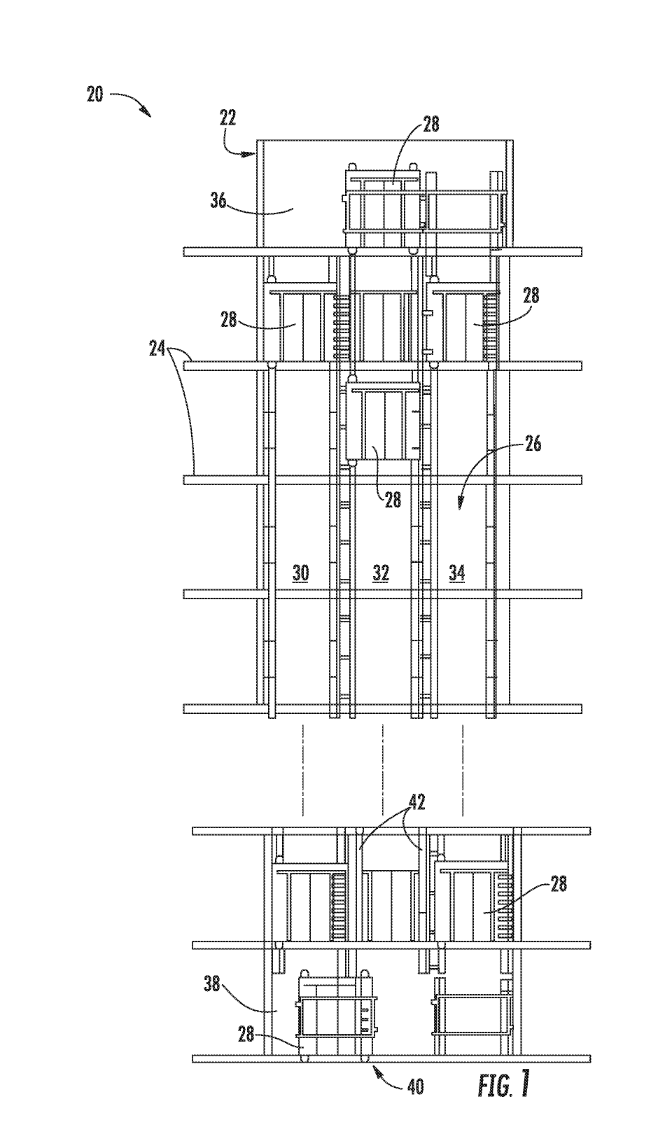

FIG. 1 depicts a self-propelled or ropeless elevator system 20 in an exemplary embodiment that may be used in a structure or building 22 having multiple levels or floors 24. Elevator system 20 includes a hoistway 26 defined by boundaries carried by the structure 22, and at least one car 28 adapted to travel in the hoistway 26. The hoistway 26 may include, for example, three lanes 30, 32, 34 with any number of cars 28 traveling in any one lane and in any number of travel directions (e.g., up and down). For example and as illustrated, the cars 28 in lanes 30, 34, may travel in an up direction and the cars 28 in lane 32 may travel in a down direction.

Above the top floor 24 may be an upper transfer station 36 that facilitates horizontal motion to elevator cars 28 for moving the cars between lanes 30, 32, 34. Below the first floor 24 may be a lower transfer station 38 that facilitates horizontal motion to elevator cars 28 for moving the cars between lanes 30, 32, 34. It is understood that the upper and lower transfer stations 36, 38 may be respectively located at the top and first floors 24 rather than above and below the top and first floors, or may be located at any intermediate floor. Yet further, the elevator system 20 may include one or more intermediate transfer stations (not illustrated) located vertically between and similar to the upper and lower transfer stations 36, 38.

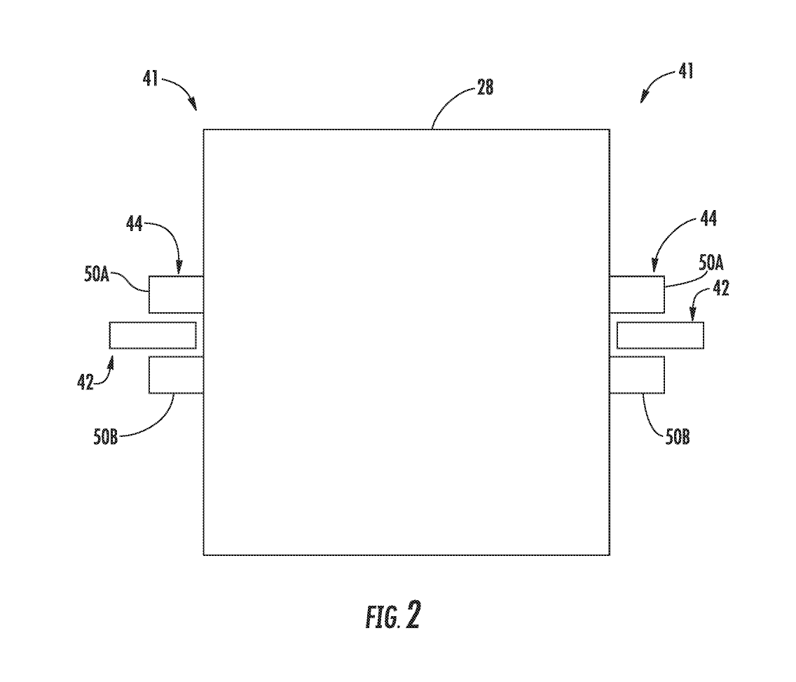

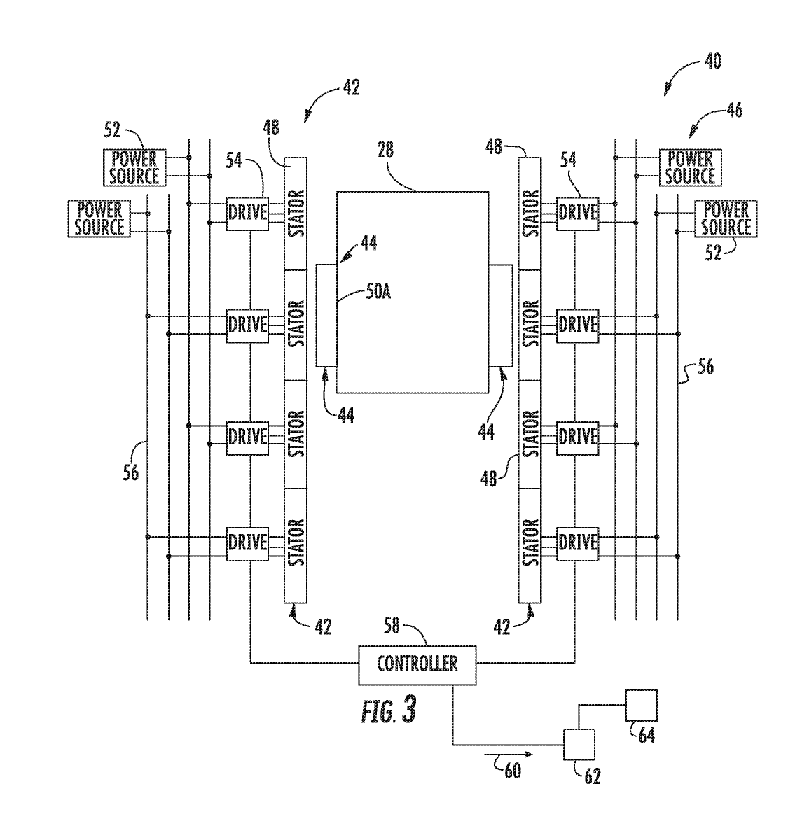

Referring to FIGS. 1 through 3, the cars 28 are propelled using a linear propulsion system 40 that may have two linear propulsion motors 41 that may be generally positioned on opposite sides of the elevator cars 28, and a control system 46 (see FIG. 3). Each motor 41 may include a fixed primary portion 42 generally mounted to the building 22, and a moving secondary portion 44 mounted to the elevator car 28. The primary portion 42 includes a plurality of windings or coils 48 that generally form a row extending longitudinally along and projecting laterally into each of the lanes 30, 32, 34. Each secondary portion 44 may include two rows of opposing permanent magnets 50A, 50B mounted to each car 28. The plurality of coils 48 of the primary portion 42 are generally located between and spaced from the opposing rows of permanent magnets 50A, 50B. Primary portion 42 is supplied with drive signals from the control system 46 to generate a magnetic flux that imparts a force on the secondary portions 44 to control movement of the cars 28 in their respective lanes 30, 32, 34 (e.g., moving up, down, or holding still). It is contemplated and understood that any number of secondary portions 44 may be mounted to the car 28, and any number of primary portions 42 may be associated with the secondary portions 44 in any number of configurations. It is further understood that each lane may be associated with only one linear propulsion motor 41 or three or more motors 41. Yet further, the primary and secondary portions 42, 44 may be interchanged.

Referring to FIG. 3, the control system 46 may include power sources 52, drives 54 (i.e., inverters), buses 56 and a controller 58. The power sources 52 are electrically coupled to the drives 54 via the buses 56. In one non-limiting example, the power sources 52 may be direct current (DC) power sources. DC power sources 52 may be implemented using storage devices (e.g., batteries, capacitors), and may be active devices that condition power from another source (e.g., rectifiers). The drives 54 may receive DC power from the buses 56 and may provide drive signals to the primary portions 42 of the linear propulsion system 40. Each drive 54 may be an inverter that converts DC power from bus 56 to a multiphase (e.g., three phase) drive signal provided to a respective section of the primary portions 42. The primary portion 42 may be divided into a plurality of modules or sections, with each section associated with a respective drive 54.

The controller 58 provides control signals to each of the drives 54 to control generation of the drive signals. The controller 58 may provide thrust commands from a motion regulator (not shown) to control generation of the drive signals by the drives 54. The drive output may be a pulse width modulation (PWM). Controller 58 may be implemented using a processor-based device programmed to generate the control signals. The controller 58 may also be part of an elevator control system or elevator management system. Elements of the control system 46 may be implemented in a single, integrated module, and/or may be distributed along the hoistway 26 and/or transfer stations 36, 38.

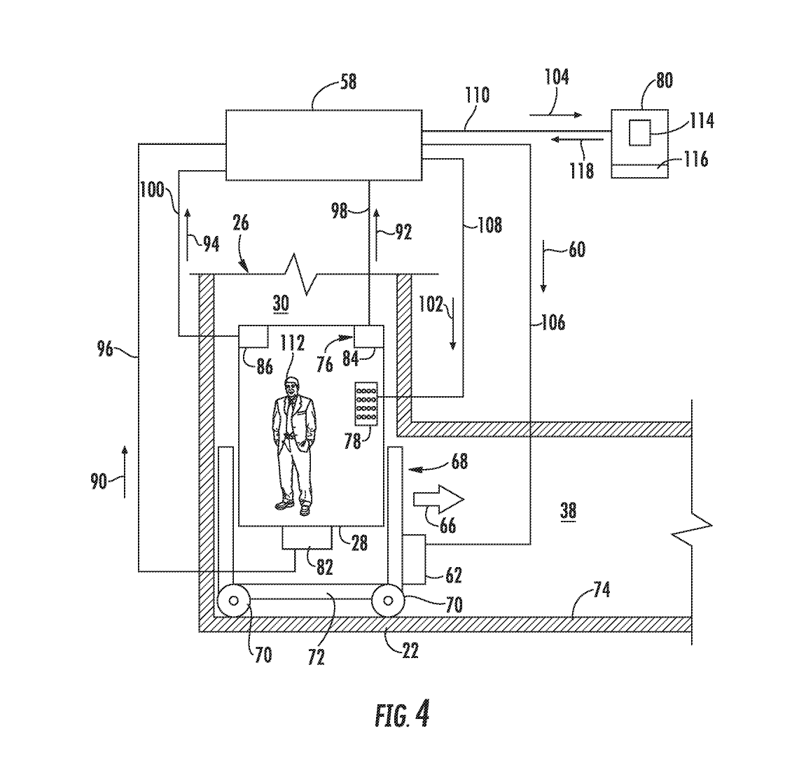

Referring to FIGS. 3 and 4, the controller 58 may further provide control signals 60 to a drive device 62 of the propulsion system 40 constructed and arranged to move the elevator car 28 through the transfer stations 36, 38. The drive device 62 may receive power from an independent power source 64, or may receive power from the power sources 52 previously described. As one non-limiting example and with reference to the lower transfer station 38, the drive device 62 may provide the propulsion for what may be in a horizontal direction (see arrow 66) of a carriage 68 located in the transfer station 38. The carriage 68 is constructed to receive and shuttle the car 28 between lanes 30, 32, 34. As another non-limiting example, the carriage 68 may include wheels 70 driven by the drive device 62 and rotationally secured to a platform 72 of the carriage 68 upon which the car 28 rests when being shuttled between lanes 30, 32, 34. The wheels 70 may roll upon a floor 74 of the transfer station 38. Alternatively, the wheels 70 may ride upon a horizontal rail (not shown) that is secured to the floor 74.

Other car shuttling means 68 may include, but are not limited to, pallets, rollers, hangers, and others. In certain embodiments, pallets may include self-propelled pallets, rail guided pallets, pallets with primary “dummies” to interface with cars 28, pallets without primary “dummies”, and others. Advantageously, by placing cars 28 on a carriage 68, cars 28 are not required to have any special features to allow cars to be moved or manipulated in the station 68. Use of shuttling means 68 may allow additional car functions such as removing refuse and others. Shuttling means 68 may also facilitate the use of forklifts to move cars 28 and/or may be used in conjunction with the station floor 74.

The propulsion system 40 may further include at least one detector 76, an elevator car occupant interface 78, and a system user interface 80. As one, non-limiting example, the at least one detector 76 may include at least one of a load detector 82 (e.g., load cell), an infrared detector 84, and a visual detector 86 (e.g., video camera). The detector(s) 76 may generally be supported and carried by the elevator car 28 and facilitate the detection of a presence 88 that may be a human presence, an inanimate presence, or other. Generally, the load detector 82 facilitates the detection of any presence based on weight and is configured to send a load signal (see arrow 90) to the controller 58. The infrared detector 84 may detect at least a temperature indicative of a human presence (i.e., body temperature) and is configured to send a temperature signal (see arrow 92) to the controller 58. The visual detector 86 facilitates the formation of a video or snapshot image and may provide an associated imaging signal (see arrow 94) to the controller 58. It is further contemplated and understood that the detector 76 may be any variety and/or combination of detectors capable of detecting a presence and preferably a human presence.

The controller 58 may include an electronic processor and a computer readable storage medium for receiving and processing any one or more of the detector signals 90, 92, 94 received from the respective detectors 82, 84, 86 over respective pathways 96, 98, 100 that may be wireless. Based on any one or combination of the input signals 90, 92, 94, the controller 58 may be configured to send the control signal 60 to the drive device 62, a notice signal (see arrow 102) to the occupant interface 78, and an information signal (see arrow 104) to the system user interface 80, and over respective pathways 106, 108, 110 that may be wireless.

The drive device 62 may be constructed and arranged to operate at a safe mode transfer speed that may be applied when the elevator car 28 is determined not to be empty and/or is determined to have a presence 112 that may be human, and operate at a normal mode transfer speed when the elevator car is determined to be empty. For example, the controller 58 may generally monitor the elevator car 28 via detectors 82, 84, 86 for a presence 112 continuously, or just prior to moving the elevator car 28 from one of the lanes 30, 32, 34 to the transfer station 38. The detectors 82, 84, 86 may operate simultaneously thus providing redundancy in operation and a higher level of detection confidence. Alternatively, the detectors may operate sequentially. For example, the load detector 82 may first detect a presence 112 based solely on weight. The infrared detector 84 may then establish a heat signature indicative of a human presence. In addition to, or alternatively, the controller 58 may be configured to detect motion and or process an image from the visual detector 86 that is indicative of a human presence 112.

The control signal 60 outputted by the controller 58 may be an indeterminate signal or a speed control signal indicative of the safe and normal mode transfer speeds. For example, if the detector signals 90, 92, 94 inputted to the controller 58 result in an indeterminate conclusion on whether there is a human presence 112 in the elevator car or not, the controller may automatically send an indeterminate signal to the drive device 62 causing the elevator car 28 to stop. Alternatively, if the controller 58 concludes there is a human presence 112, the controller 60 may output a speed control signal to the drive device 62 causing the drive device to initiate the safe mode transfer speed. If the controller concludes there is no human presence, and/or no presence, the controller 58 may not output any control signal 60 to the drive device, causing the drive device to to automatically initiate the normal mode transfer speed. Alternatively, the propulsion system 40 may require an affirmative control signal 60 for any movement of the elevator car 28. In such an example, the controller may output a control signal indicative of a normal mode transfer speed. It is further contemplated and understood that the same or similar control signals 60 may be outputted by the controller 58 to the drives 54 of motors 41 (i.e., or motor modules) located generally near the transfer stations 36, 38. In this way, transitioning movement of the elevator car 28 from any one lane 30, 32, 34 and into any one of the transfer stations 36, 38 may also be conducted in a safe mode transfer speed if a human presence 112 is detected.

The system user interface 80 is configured to receive the information signals 104 indicative of any existence of a presence (i.e., and no presence) from the controller 58. The user interface 80 may further include a video or visual monitor 114 and an entry device 116 (e.g., keyboard), and is generally manned by, for example, a supervising human (not shown). Based, at least in-part on, the information signals 104, the supervising human may be capable of overriding the control signals 60 outputted by the controller 58 to the drive device 62 by sending a command signal 118 to the controller 58. In addition, when the controller 58 sends the indeterminate control signal 60 to the drive device 62 causing the elevator car 28 to stop, the controller 58 may simultaneously include this action as part of the information signal 104 sent to the system user interface 80. When sent, the supervising human may have the opportunity to send a command signal 118 initiating movement of the car 28. Moreover, the information signal may include a visual of the elevator car 28 from the visual detector 86 displayed on the monitor 114. With such imaging, the supervising human may be capable of making better informed decisions on whether to override the controller 58 or not.

The occupant interface 78 may receive the automated notice signals 102 from the controller 58. For example, such a notice signal 102 may be indicative of an automated message (e.g., visual or audible), informing the human presence 112 (i.e. car occupants), to exit from the car 28. Alternatively, the notice signal 102 may be indicative of informing the human presence 112 that the car 28 is about to slow down and enter the transfer station 38, or may be indicative any other variety of notices. It is further contemplated and understood that the notice signal 102 may also come directly from the system user interface 80 and may be an audible instruction spoken by, for example, the supervising human.

While the present disclosure is described with reference to exemplary embodiments, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

What is claimed is:

1. A ropeless elevator system comprising:
an elevator car constructed and arranged to move along a hoistway and into a transfer station in communication with the hoistway;
an electronic controller configured to control speed of the elevator car when at least in the transfer station; and
a first detector supported by the elevator car and configured to send a first signal to the electronic controller at least in-part indicative of a presence in the elevator car, and wherein the electronic controller outputs a speed control signal indicative of the presence.

2. The ropeless elevator system set forth in claim 1, wherein the first detector is a load detector.

3. The ropeless elevator system set forth in claim 1, wherein the first detector is a video detector.

4. The ropeless elevator system set forth in claim 1, wherein the first detector is an infrared detector configured to measure at least temperature.

5. The ropeless elevator system set forth in claim 1 further comprising:
an infrared detector supported by the elevator car and configured to send a temperature signal to the electronic controller indicative of the presence being human, and wherein the first detector is a load detector indicative of the existence of the presence in the elevator car.

6. The ropeless elevator system set forth in claim 1 further comprising:
a visual detector supported by the elevator car and configured to send an imaging signal to the electronic controller for detecting the presence, and wherein the first detector is a load detector.

7. The ropeless elevator system set forth in claim 1 further comprising:
a system user interface configured to receive an information signal outputted by the electronic controller and based on the presence, and configured to send a command signal to the electronic controller initiated by a human user.

8. The ropeless elevator system set forth in claim 1 further comprising:
a drive device constructed and arranged to move the elevator car in the transfer station, and wherein the speed control signal is received by the drive device and is indicative of a safe mode transfer speed that is slower than a normal mode transfer speed applied when the elevator car is empty.

9. The ropeless elevator system set forth in claim 8, wherein the electronic controller is configured to output an indeterminate signal to the drive device when the presence is indeterminate and the drive device is constructed and arranged to stop the elevator car upon receipt of the indeterminate signal.

10. The ropeless elevator system set forth in claim 9 further comprising:
a system user interface configured to receive an information signal outputted by the electronic controller and based on the indeterminate signal, and configured to send a command signal to the electronic controller initiated by a human user commensurate of selectively running the elevator car at the safe mode transfer speed or the normal mode transfer speed.

11. The ropeless elevator system set forth in claim 10 further comprising:
an occupant interface supported by the elevator car and configured to receive a notice signal outputted by the electronic controller and providing notice information to the elevator car occupants.

12. The ropeless elevator system set forth in claim 11, wherein the notice information is instruction to leave the elevator car.

13. A method of transferring an elevator car from a hoistway and into a transfer station comprising:
monitoring an elevator car for a presence by an electronic controller;
automatically moving the elevator car from the hoistway and into the transfer station at a slow speed if the presence is detected; and
automatically moving the elevator car from the hoistway and into the transfer station at a normal speed greater than the slow speed if the presence is not detected.

14. The method set forth in claim 13, wherein the monitoring is conducted by detector configured to send a signal to the electronic controller indicative of a presence.

15. The method set forth in claim 14, wherein the detector is constructed and arranged to detect the presence as a human presence.

16. The method set forth in claim 13, wherein a speed control signal is outputted by the controller for automatically moving the elevator car from the hoistway and into the transfer station at the slow speed.

17. The method set forth in claim 13 further comprising:
automatically stopping the elevator car by the controller and prior to moving the elevator car into the transfer station if the existence of the presence in the elevator car is indeterminate.

18. The method set forth in claim 17 further comprising:
displaying a visual image of the elevator car upon a system user interface at least when the existence of the presence is indeterminate.

19. The method set forth in claim 18 further comprising:
re-initiating movement of the elevator car by a supervising human through the system user interface and based on the visual image.
